(19) United States
(12) Patent Application Publication
(10) Pub. No.: US 2014/0366986 A1
(43) Pub. Date: Dec. 18, 2014

(54) Injection Needle For A Delivery Head For Fluid Product, And Delivery Head Comprising Said Injection Needle

(71) Applicant: Mirko Bertoli, Medolla (IT)

(72) Inventor: Mirko Bertoli, Medolla (IT)

(73) Assignee: CPS COLOR EQUIPMENT SPA CON UNICO SOCIO, San Felice Sul Panaro (IT)

(21) Appl. No.: 13/824,759

(22) PCT Filed: Sep. 20, 2011
(86) PCT No.: PCT/IB2011/002174

§ 371 Date: Nov. 12, 2013

(30) Foreign Application Priority Data
Sep. 20, 2010 (IT) UD2010A000168
Sep. 20, 2011 (IB) PCT/IB2011/002174

(51) Int. Cl. B01F 15/02

(52) U.S. Cl. CPC B01F 15/0203
USPC 141/311 R

(57) ABSTRACT

An injection needle (10) for a delivery head (30) for fluid products, such as for example pigments or coloring products, inside a container containing a paint base to obtain a coloring product, comprises internally an axial hole (20) which develops along a first central axis (X) for the passage of the fluid product toward a delivery opening (23). A channel (22) is provided to connect the opening (23) with the axial hole (20). The channel (22) develops along a second axis (Y) inclined by a desired acute angle with respect to said first axis (X).

### CROSS-REFERENCE TO RELATED APPLICATIONS

This Application is a U.S. National Phase Filing Under 35 U.S.C. §371 based on PCT/IB2011/002174, filed Sep. 20, 2011, the entire disclosure of which is incorporated by reference herein.

### BACKGROUND OF THE INVENTION

1. Field of the Invention

The present invention concerns an injection needle for a fluid product, for example a pigment or coloring product, usable for example in a dispensing machine.

2. Description of Related Art

Dispensing or delivery machines for coloring products are known, able to introduce a desired quantity of coloring pigments into a container containing a paint base, to obtain the desired coloring product.

Such machines normally comprise at least a delivery head provided with a plurality of injection needles. The needles perform both the function of perforating the lid of the container, and also injecting inside it the desired quantity of coloring pigment.

One known problem of injection needles is the formation of drops and residues of coloring product in correspondence with the point where the pigment is delivered. Such residues, in time, tend to dry out, considerably worsening the performance of the needle.

The European patent application EP-A-2.040.830 (EP'830), in the name of the Applicant, discloses an injection needle having a tubular element and a solid perforation end, having a pointed shape by means of which the lid of the container containing the paint base is perforated. Just above the perforation end, on the lateral surface of the tubular element, the needle has an opening for the passage of the fluid product to be delivered. The axis of the opening hole is perpendicular to the axis of the axial hole of the tubular element. Although this solution is advantageous, since it integrates in a single needle both the function of perforation and of delivery, it may have the disadvantage, in the case of a delivery head with a lot of needles, also close together, that it dirties the adjacent injection needles with the jet of fluid product that is delivered substantially laterally through the opening of each needle, directly horizontally against the adjacent needles. This causes an accumulation of dirt and residue that dries out, to the detriment of the performance of the delivery head, and also does not provide the guarantee that all the fluid product delivered goes into the paint base below, inasmuch as part of it is sprayed inadvertently on the adjacent needles with the risk of contaminating the colorant delivered in the adjacent needle. Especially in the case of a formulation of the coloring products that requires great accuracy in the dosage of the various components, this may entail the preparation of a final product that does not have the expected quality characteristics.

The prior art document GB-A-2048825 describes a machine for mixing coloring products provided with pointed delivery nozzles that have an axial hole and a lateral opening.

The prior art document DE-A-3410783, which however concerns the technical field of textiles, discloses a quilting machine for making quilting operations in the textile field. The quilting machine provides one or more needles, each needle is associated with a respective yarn, called the needle yarn. The needle has a point, an axial hole and a lateral opening for the passage of the needle yarn. The prior art document SU-A-1701766, also concerning the technical field of textiles, discloses a needle for a textile yarn that has an axial hole and a lateral opening for the passage of the yarn.

One purpose of the present invention is to obtain an injection needle which, delivering the fluid product, does not interfere with and dirty the other needles of the delivery head on which they are installed.

Another purpose is to obtain an injection needle that avoids the problem of the drops and residues of colorant drying out on the point.

Another purpose is to obtain a delivery head for a fluid product having a plurality of injection needles that do not dirty each other during the delivery operation.

The Applicant has devised, tested and embodied the present invention to overcome the shortcomings of the state of the art and to obtain these and other purposes and advantages.

### BRIEF SUMMARY OF THE INVENTION

The present invention is set forth and characterized in the independent claims, while the dependent claims describe other characteristics of the invention or variants to the main inventive idea.

In accordance with the above purposes, an injection needle according to the present invention is used for a delivery head for fluid products, such as for example pigments or coloring products, inside a container containing a paint base to obtain a coloring product.

The needle according to the present invention comprises, aligned along a central common first axis, a connection element connecting to the delivery head, a tubular element and a perforation element formed by a first portion, substantially with a rectilinear development which extends from the tubular element, and by a second portion which has a pointed end having a lateral surface symmetrical with the first axis and curved in the direction of the first axis converging progressively toward a point provided on the first axis. By means of the pointed end it is possible to both perforate the lid of the container and also to deliver inside it a desired quantity of the fluid product.

Inside the needle an axial hole is made, which develops along the first axis for the passage of the fluid product toward a delivery opening made on the lateral surface of the pointed end of the perforation element. The needle comprises a channel, provided to connect the opening with the axial hole.

According to the present invention, the channel develops along a second axis, inclined by a desired acute angle with respect to the first axis. The inclination of the second axis of the channel is comprised between about 15° and about 25°, determining an elongated shape of the delivery opening.

Thanks to the inclination of the channel, when the fluid product is delivered there is no interference with or dirtying of the other needles of the delivery head on which they are installed.

Furthermore, thanks to the inclination of the channel and its specific conformation, the problem of drops and residues of colorant drying up on the point of the needle is avoided.

In some forms of embodiment, the inclination of the second axis of the channel is comprised between about 18° and about 22°.

In some forms of embodiment, the channel has a circular cross section.

In variant forms of embodiment of the present invention, the nominal diameter of the channel is comprised between about 2.5 mm and about 3.5 mm, preferably between about 2.8 mm and about 3.2 mm. This range is particularly suitable for delivering coloring products, both in terms of quality delivery and also to promote dripping.

In some variant forms of embodiment, the axial hole develops along the needle from the connection element through the tubular element as far as the perforation element, for the passage of the fluid product, for example from a tank associated with the delivery head to which the needle is connected, to the delivery opening to deliver the fluid product.

With the present invention, the delivery opening is so made in a substantially elongated shape, due to the inclination of the channel which intersects with the converging curved lateral surface of the pointed end. The elongated shape has shown itself to be advantageous in promoting the dripping of the fluid product, that is, it functions as a drop breaker, in that it promotes the formation of the drop due to gravity and reduces the formation of dried residues on the needle. In some forms of embodiment, the elongated shape of the delivery opening is substantially ovoid, elliptic or similar.

The solution according to the present invention in particular has shown itself to be advantageous in the case of coloring products with a high specific weight which tend to dry up, since the formation of the drop due to gravity causes it to be detached and promotes dripping.

Furthermore, the inclination of the channel, which opens toward the outside through the delivery opening, prevents the fluid product from being delivered laterally directly horizontally against the adjacent needles in the delivery head, preventing them from getting dirty.

The present invention also concerns a delivery head for fluid products, for example pigments or other coloring products, which comprises a plurality of injection needles as described above, for example for machines to dispense or deliver coloring products, able to introduce a desired quantity of coloring pigments into a container containing a paint base, to obtain the desired coloring product.

Advantageously, the interaxis at which the needles are positioned one from the other in the delivery head is a length selected in correlation at least to the inclination of the second axis of the channel, preventing the fluid product delivered by one needle from dirtying the surface of adjacent needles.

### BRIEF DESCRIPTION OF THE SEVERAL VIEWS OF THE DRAWINGS

These and other characteristics of the present invention will become apparent from the following description of a preferential form of embodiment, given as a non-restrictive example with reference to the attached drawings wherein:

FIG. 1 is a perspective view of an injection needle according to the present invention;

FIG. 2 is a plan view from below of the needle in FIG. 1;

FIG. 3 is a longitudinal section of the needle in FIG. 1;

FIG. 4 is a lateral view of a part of the needle in FIG. 1;

FIG. 5 is a plan view from below of the part in FIG. 4;

FIG. 6 is a section from VI to VI of FIG. 5;

FIG. 7 is a lateral view of a variant of a part of the needle in FIG. 1;

FIG. 8 is a longitudinal section of the variant in FIG. 7;

FIG. 9 is a lateral view of a delivery head comprising a plurality of injection needles according to the present invention;

FIG. 10 is a plan view of the delivery head in FIG. 9;

FIG. 11 is a section of the delivery head in FIG. 9;

FIG. 12 is a perspective view of the delivery head in FIG. 9.

To facilitate comprehension, the same reference numbers have been used, where possible, to identify identical common elements in the drawings. It is understood that elements and characteristics of one form of embodiment can conveniently be incorporated into other forms of embodiment without further clarifications.

### DETAILED DESCRIPTION OF THE INVENTION

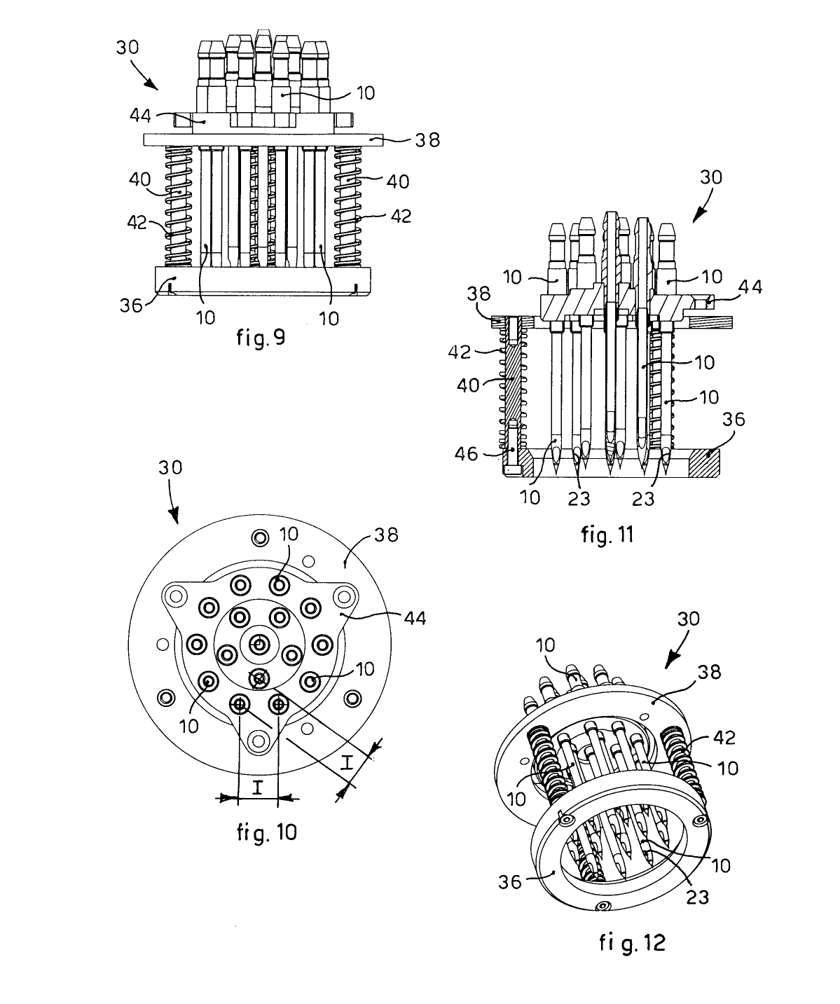

With reference to the attached drawings, an injection needle 10 according to the present invention is used in a machine for the automatic delivery, dispensation and/or distribution of fluid products, for example coloring products, able to introduce a dosed quantity of coloring pigments into a container containing a paint base, to obtain the desired coloring product. In particular, the machine typically comprises a delivery head 30 on which a plurality of needles 10 are mounted, as can be seen in FIGS. 9-12. A machine of this type is described, for example, in the cited European patent application EP'830, or in the Italian patent application UD2010A000126 in the name of the present Applicant.

The container is typically provided with a closing lid that is perforated by the needles of the perforation head. In some forms of embodiment, the closing lid has a portion at least partly made with a membrane made of plastic material, able to dilate when the needles are inserted through the membrane in order to carry out the delivery, and to re-compact when the needles are extracted from the container, as described for example in the cited European patent application EP'830, or in the Italian patent application UD2010A000126 in the name of the present Applicant.

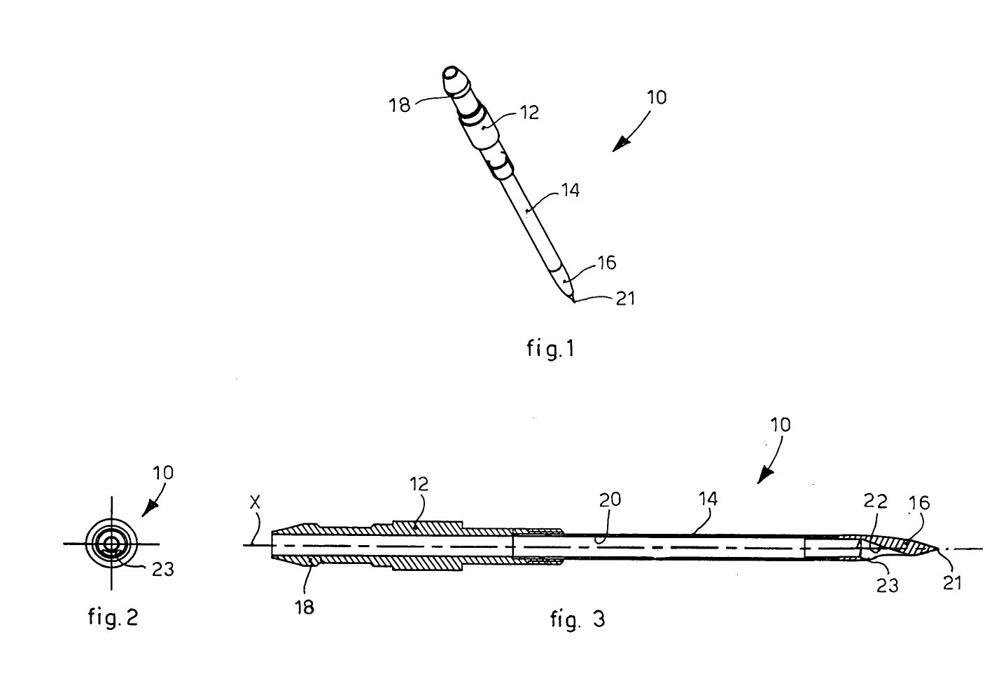

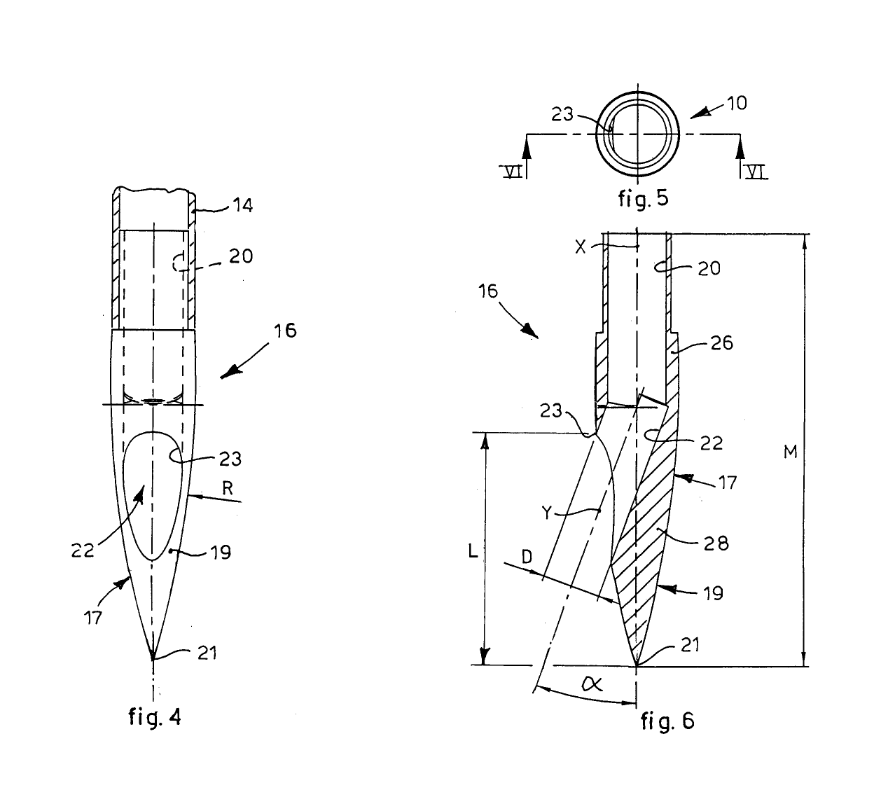

According to one form of embodiment, shown in FIGS. 1-6, the needle 10 comprises, aligned along a central common first axis X, a connection element 12 connecting to the delivery head 30, a tubular element 14 and a perforation element 16. The elements 12, 14 and 16 are hollow inside to define a pipe for the passage of the fluid product to be delivered.

In this case, the tubular element 12 is configured as an oblong, cylindrical element, hollow inside, like a cannula.

The perforation element 16 is suitable both to perforate the lid of the container, and also to deliver the fluid product inside it.

In some forms of embodiment, the tubular element 14 is in a central position, while the connection element 12 and the perforation element 16 extend from the respective opposite ends of the tubular element 14, one to connect to the delivery head 30, the other to deliver the fluid product inside the container (FIGS. 1 and 3).

In some forms of embodiment, the elements 12, 14 and 16 are constrained reciprocally by welding or gluing, depending on the material they are made of. For example the elements 12, 14 and 16 are made of stainless steel.

In other forms of embodiment, the elements 12 and 14, or 14 and 16, can be made in a single piece.

Still other forms of embodiment can provide that the elements 12, 14 and 16 can be made in a single piece.

In this case, the connection element 12 has a portion 18 (FIG. 3), for example threaded, or with snap-in attachment means or geometric coupling, for connection to the delivery head 30.

The perforation element 16 has a pointed end 17 having a lateral surface 19 axial-symmetrical with respect to the first axis X and with a curved section that progressively converges toward a point 21 provided on the first axis X, by means of which it is possible to perforate the lid of the container and also to deliver inside it a desired quantity of the fluid product. As can be seen from the attached figures, the point is solid, that is, it does not have any through holes or cavities.

The axial-symmetrical shape of the pointed end 17 determines a perforation of the lid of the container so that the section of the hole obtained is very limited and uniform.

An axial hole 20 is provided along the needle 10, defining the pipe that goes from the connecting element 12 through the tubular element 14, as far as the perforation element 16. The axial hole 20 allows the passage of the fluid product, for example from a tank associated with the delivery head 30 with which the needle 10 is connected, to a delivery opening 23 (FIGS. 2, 4, 5 and 6) provided on the perforation element 16, by means of which the fluid product is delivered.

According to one feature of the present invention, the delivery opening 23 is made on the lateral surface 19 of the pointed end 17 of the perforation element 16 and a channel 22 is provided for the passage of the fluid product, which connects the opening 23 with the axial hole 20. The channel 22 defines a rectilinear path from the axial hole 20 to the opening 23 and in particular develops along a second axis Y, which is inclined by a desired acute angle α with respect to the first axis X (FIG. 6).

According to some forms of embodiment of the present invention, the angle α of inclination of the second axis Y of the channel 22 is comprised between about 15° and about 25°, preferably between about 18° and about 22°, determining an elongated shape of the delivery opening 23. One example for the value of the angle α is about 20°. One advantage of the inclination of the channel 22 is that it promotes dripping. Furthermore, in combination with the axial-symmetrical shape of the pointed end 17, this solution prevents the so-called “tear-off” effect, that is, the removal of part of the lid and the possible blockage or obstruction of the needle, when the needle 10 perforates the lid of the container.

According to the present invention some forms of embodiment of, the channel 22 has a circular cross section.

According to some forms of embodiment of the present invention, the nominal diameter D of the circular section of the channel 22 is comprised between about 2.5 mm. and about 3.5 mm, preferably between about 2.8 mm and about 3.2 mm. This range is particularly suitable for delivering coloring products, in particular it is advantageous since it allows to keep the delivery pressure substantially constant, preventing the spraying effect that could dirty the adjacent needles in the delivery head. Furthermore, in combination with the inclination of the channel 22, this range reduces the drying-out effect and promotes the dripping of the coloring product, obtaining a compromise with the need to prevent the formation of blockages of material on the needle 10.

According to the form of embodiment in FIGS. 1-6, the lateral surface 19 of the curved pointed end 17, in longitudinal section, has a continuous convex development without changing from convex to concave.

This form of embodiment allows to minimize the sizes of the drop of coloring product that is delivered, and hence of the residue that dries out. This advantage is obtained, especially, with fluid products, for example colorants, with a high drying capacity and high specific weight, therefore more subject to the force of gravity.

Thanks to the limited size of the residual drop on the needle 10, the scraping effect through the lid when the needle 10 is extracted, after the delivery step, determines an optimum mechanical cleaning of the residue from the needle 10.

Another advantage of the present invention is that the section of the hole that is made on each occasion by the perforating action of the needles through the lid of the container is very small. This is very convenient, especially in forms of embodiment where the lid has an elastic membrane able to be perforated and re-closed as described above.

In variant forms of embodiment, the curved lateral surface 19 is defined by the rotation around the first axis X by an arc of a circle.

In some variant forms of embodiment, the length of the radius R of the circle is comprised between about 45 mm and about 55 mm, preferably between about 48 mm and about 52 mm.

In some forms of embodiment, the shape of the pointed end 17 defined by the lateral surface 19 is rounded, or convex, substantially ogival. This shape prevents the formation of zones, grooves or undercuts of the needle 10 where the colorant could be deposited undesirably after delivery.

In some forms of embodiment, the perforation element 16 is formed by a first portion 26, substantially with a rectilinear development that extends from the tubular element 14, and a second portion 28, formed by the curved lateral surface 19 converging toward the point 21 that defines the pointed end 17.

In some forms of embodiment, the delivery opening 23 is made on the second portion 28 that defines the pointed end 17.

In some forms of embodiment, the length L of the second portion 28 is comprised between about 10 mm and about 20 mm, preferably between about 12 mm and about 15 mm.

In some forms of embodiment, the length M of the perforation element 16 is comprised between about 20 and about 30 mm.

In other forms of embodiment, the ratio between the length L of the second portion 28 and the length M of the perforation element 16 is comprised between 0.5 and about 0.7, preferably between about 0.55 and about 0.65.

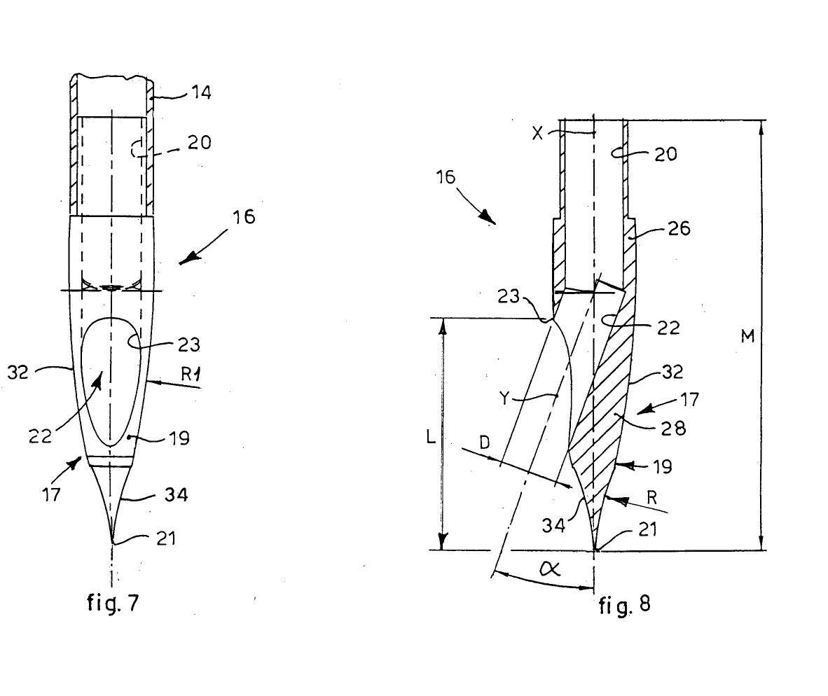

In another form of embodiment shown in FIGS. 7 and 8, the lateral surface 19 of the pointed end 17 has a development in longitudinal section that varies continuously from convex, in a first segment 32, to concave in a second segment 34. In variants of this form of embodiment, the first segment 32 of the curved lateral surface 19 is defined by the rotation around the first axis X by a first arc of a circle with a center positioned on the opposite side with respect to the first axis X, whereas the second segment 34 is defined by the rotation around the first axis X by a second arc of a circle with a center positioned on the same side with respect to the first axis X.

In some variant forms of embodiment, the length of the radius R1 of the first circle is comprised between about 45 mm and about 55 mm, preferably between about 48 mm and about 52 mm, while the length of the radius R2 of the second circle is comprised between about 13 mm and about 15 mm, preferably between about 13.5 mm and about 14.5 mm.

FIGS. 9-12 show how a plurality of needles 10 according to the invention can be mounted on the delivery head 30.

The delivery head 30 in this case comprises a support collector 44 for the needles 10 associated with a pair of annular platelets 36, 38, respectively lower and upper. The lower platelet 36 is used to press on the container or tin of paint that is positioned below. The upper platelet 38 acts as a guide for peripheral columns 40 constrained by means of screws 46 to the lower platelet 36 and associated with springs to compress the needles 10.

The interaxis, that is, the reciprocal distance referred to the relative first axes X of each needle 10, at which the needles 10 are positioned with respect to each other (FIG. 10), has a length I comprised between about 12 mm and about 15 mm. The length I is selected, in correlation with the inclination of the channel 22 of the needle 10, between about 15° and about 25°, preferably between about 18° and about 22°, and possibly also with the length M of the perforation element 16, so as to prevent the stream of fluid product delivered by one needle from going against the surface of adjacent needles, thus avoiding dirtying them with the risk of contaminating the colorant delivered in the adjacent needle. In particular, it is advantageous to this purpose that the ratio between the length I of the interaxis between each needle 10 and the length M of the perforation element 16 is comprised between about 0.4 and about 0.75.

1. An injection needle for a delivery head for fluid products, such as pigments or coloring products, inside a container containing a paint base to obtain a coloring product, wherein the injection needle for a deliver head comprises, aligned along a central common first axis, a connection element connecting to said delivery head, a tubular element and a perforation element, formed by a first portion, substantially with a rectilinear development which extends from the tubular element, and by a second portion which has a pointed end having a lateral surface symmetrical with respect to said first axis and curved in the direction of the first axis converging progressively toward a point provided on said first axis, an axial hole being made inside said needle which develops along said first axis for the passage of the fluid product toward a delivery opening made on the lateral surface of the pointed end of the perforation element, a channel being provided to connect said opening with said axial hole, said channel developing along a second axis inclined by a desired acute angle with respect to said first axis, the inclination of said second axis of the channel being comprised between about 15° and about 25°, determining an elongated shape of the delivery opening, wherein said channel has a circular cross section and the nominal diameter of said channel is comprised between about 2.5 mm and about 3.5 mm.

2. (canceled)

3. The needle as in claim 21, wherein the nominal diameter of said channel is comprised between about 2.8 mm and about 3.2 mm.

4. The needle as in claim 1 hereinbefore, wherein said axial hole develops from the connection element through the tubular element, as far as the perforation element, for the passage of the fluid product toward the delivery opening.

5. The needle as in claim 1, wherein said lateral surface of the pointed end, in longitudinal section, has a continuous convex development.

6. The needle as in claim 1, wherein said lateral surface is defined by the rotation around said first axis by an arc of a circle.

7. The needle as in claim 6, wherein the length of the radius of said circle is comprised between about 45 mm and about 55 mm, preferably between about 48 mm and about 52 mm.

8. The needle as in claim 1, wherein the shape of the pointed end defined by said lateral surface is substantially ogival.

9. The needle as in claim 1, wherein said delivery opening is made on the second portion which defines the pointed end.

10. The needle as in claim 1, wherein the length of the second portion is comprised between about 10 mm and about 20 mm, preferably between 12 mm and about 15 mm.

11. The needle as in claim 1, wherein the length of the perforation element is comprised between about 20 mm and about 30 mm.

12. The needle as in claim 1, wherein said lateral surface of the pointed end, in longitudinal section, has a development which varies, continuously, from convex in a first segment to concave in a second segment.

13. The needle as in claim 12, wherein said first segment of said lateral surface is defined by the rotation around said first axis by a first arc of a circle with a center of rotation positioned on the opposite side with respect to said first axis, while said second segment is defined by the rotation around said first axis by a second arc of a circle, positioned on the same side with respect to said first axis.

14. The needle as in claim 12, wherein the length of the radius of said first circle is comprised between about 45 mm and about 55 mm, preferably between about 48 mm and about 52 mm, while the length of the radius of said second circle is comprised between 13 mm and about 15 mm, preferably between about 13.5 mm and about 14.5 mm.

15. A delivery head for fluid products, such as pigments or coloring products, inside a container containing a paint base to obtain a coloring product, comprising a plurality of injection needles, each needle comprising, aligned along a central common first axis, a connection element connecting to said delivery head, a tubular element and a perforation element, formed by a first portion, substantially with a rectilinear development which extends from the tubular element, and by a second portion which has a pointed end having a lateral surface symmetrical with respect to said first axis and curved in the direction of the first axis converging progressively toward a point provided on said first axis, an axial hole being made inside said needle which develops along said first axis for the passage of the fluid product toward a delivery opening made on the lateral surface of the pointed end of the perforation element, a channel being provided to connect said opening with said axial hole, said channel developing along a second axis inclined by a desired acute angle with respect to said first axis, the inclination of said second axis of the channel being comprised between about 15° and about 25°, determining an elongated shape of the delivery opening.

16. The delivery head as in claim 15, wherein the interaxis at which the needles are positioned from each other is a length comprised between about 12 mm and about 15 mm.

17. The delivery head as in claim 15, wherein the interaxis at which the needles are positioned from each other is a length selected in correlation with the inclination of the second axis of the channel.

18. The delivery head as in claim 15, wherein the interaxis at which the needles are positioned from each other is a length selected in correlation with the length of the perforation element.

19. The delivery head as in claim 18, wherein the ratio between the length of the interaxis between each needle and the length of the perforation element is comprised between 0.4 and about 0.75.

20. The needle as in claim 13, wherein the length of the radius of said first circle is comprised between about 45 mm and about 55 mm, preferably between about 48 mm and about 52 mm, while the length of the radius of said second circle is comprised between 13 mm and about 15 mm, preferably between about 13.5 mm and about 14.5 mm.

21. The delivery head as in claim 16, wherein the interaxis at which the needles are positioned from each other is a length selected in correlation with the inclination of the second axis of the channel.

22. The delivery head as in claim 16, wherein the interaxis at which the needles are positioned from each other is a length selected in correlation with the length of the perforation element.

23. The delivery head as in claim 17, wherein the interaxis at which the needles are positioned from each other is a length selected in correlation with the length of the perforation element.
